(19) United States
(12) Patent Application Publication
(10) Pub. No.: US 2026/0071034 A1
(43) Pub. Date: Mar. 12, 2026

(54) CARBON NANOTUBE SELF-REINFORCED COMPOSITE AND METHOD FOR PREPARING THE SAME

(71) Applicant: Industry-Academic Cooperation Foundation, Dankook University, Gyeonggi-do (KR)

(72) Inventors: Won Jun Lee, Gyeonggi-do (KR); Keunil Park, Gyeonggi-do (KR)

(73) Assignee: Industry-Academic Cooperation Foundation, Dankook University, Gyeonggi-do (KR)

(21) Appl. No.: 19/317,646

(22) Filed: Sep. 3, 2025

(30) Foreign Application Priority Data
Sep. 9, 2024 (KR) 10-2024-0122131

(51) Int. Cl. C08J 5/04; H01M 4/62

(52) U.S. Cl. CPC C08J 5/042; H01M 4/625; C08J 2327/18

(57) ABSTRACT

Provided is a self-reinforced composite comprising: a matrix comprising carbon nanotubes; and reinforcements positioned on the matrix and comprising the carbon nanotubes. The self-reinforced composite of the present disclosure has high conductivity and ductility. In addition, the reinforcements are arranged to cross each other, which enables a nonlinear S-S curve behavior to be achieved while suppressing damage mechanisms that cause early failure, thereby improving strength and fracture strain.

### TECHNICAL FIELD

The following disclosure relates to a carbon nanotube self-reinforced composite and a method for preparing the same, and in particular, to a carbon nanotube self-reinforced composite having high conductivity and ductility and a method for preparing the same.

### BACKGROUND ART

Recently, research is being conducted on self-reinforced composites (SRCs), which are single polymer composites obtained by using reinforcements and matrices which are different from each other, but chemically identical to each other. Such self-reinforced composites have recently been in the spotlight because the self-reinforced composites may overcome interface problems of polymer composites so that composite materials having excellent properties may be provided. Self-reinforced composites (SRCs), that is, single polymer composites, are composite materials in which a polymer matrix is reinforced with oriented fibers, tapes, or particles of polymers that are chemically identical to each other but physically different from each other. Such systems may overcome the interface problems of conventional composite materials (combinations of two or more physically and chemically different materials), and uniformity of the components provides great advantages, especially for biomaterial applications.

Polymers used in existing self-reinforced composites comprise polyethylene (PE), polypropylene (PP), polyethylene terephthalate (PET), etc., and polyethylene self-reinforced composites have superior rigidity and toughness compared to other materials, and when high tenacity polyethylene (HTPE) is applied thereto in the future, more excellent properties may be exhibited. However, when reinforcement components are added to the polyethylene self-reinforced composites to improve properties such as strength, there has been a problem of reduced compatibility. In addition, since the polyethylene self-reinforced composites contain reinforcements such as glass fiber or carbon fiber, it is difficult for recycling. In addition, since the polyethylene self-reinforced composites have a form in which different materials are combined, it is difficult for expansion into a thick form by stacking multiple layers.

Meanwhile, carbon fiber reinforced plastic (CFRP) is a material having properties such as specific strength, specific elasticity, and heat resistance, which are very superior to other types of fibers, and having the advantage of preparing a lightweight, high-strength, and high-elasticity composite. As for the carbon fiber reinforced plastic, when the matrix containing carbon fibers is plastic, it is called carbon fiber reinforced plastic, when the matrix containing carbon fibers is metal, it is called carbon fiber reinforced metal, and when the matrix containing carbon fibers is carbon, it is called a carbon composite. Although the above carbon fiber reinforced plastic has high stiffness and strength, it has the difficulty of reducing the design tolerance and failing to realize the full potential of a material due to sudden brittle fracture without a yield point due to linear elastic fracture stress-strain behavior.

### DISCLOSURE

### Technical Problem

An embodiment of the present disclosure is directed to providing a carbon nanotube-based self-reinforced composite having high conductivity and ductility.

Another embodiment of the present disclosure is directed to providing a method for preparing a self-reinforced composite.

Still another embodiment of the present disclosure is directed to providing an electrode for an electrochemical device comprising a self-reinforced composite.

### Technical Solution

Various modifications can be made and various embodiments may be implemented in the present disclosure, and specific embodiments are illustrated in the drawings and described in detail. However, these embodiments are not intended to limit the present disclosure to specific embodiments, and should be understood to comprise all modifications, equivalents, and substitutes included in the spirit and scope of the present disclosure.

Terms used in the present application are only used to describe specific embodiments and are not intended to limit the present disclosure. Singular expressions include plural expressions unless the context clearly indicates otherwise. In the present specification, terms such as “comprise” or “have” are intended to designate the presence of features, numbers, steps, operations, components, parts, or combinations thereof described in the specification and it should not be understood as precluding the possibility of the presence or addition of one or more other features, numbers, steps, operations, components, parts, or combinations thereof.

When amounts, concentrations, or other values or parameters herein are given as ranges, preferred ranges, or lists of upper desirable values and lower desirable values, it should be understood as specifically disclosing all ranges formed by any pair of any upper range limit or preferred value and any lower range limit or preferred value, regardless of whether the scope is separately disclosed.

Where ranges of numerical values are stated herein, unless otherwise stated, it is intended that the endpoints of the range and the scope of the present disclosure within the range are not limited to the specific values stated when defining the range.

As used herein, the term “self-reinforced composite (SRC)” refers to a so-called single-polymer composite using a matrix and a reinforcement that are physically different from each other, but are chemically identical to each other.

As used herein, the term “reinforcement” refers to a material responsible for mechanical properties in the self-reinforced composite. In general, the reinforcement may be formed in various forms such as particles, flakes, fibers, and the like.

As used herein, the term “matrix” refers to a base material that binds reinforcements into one and protects the reinforcements from the external environment in a self-reinforced composite. In general, the matrix may be formed in various forms such as metals, ceramics, polymers, and the like.

Unless defined otherwise, all terms used herein, including technical and scientific terms, have the same meaning as those commonly understood by those skilled in the art in the technical field to which the present disclosure pertains. Terms as those defined in generally used dictionaries are to be interpreted to have the meanings consistent with the contextual meanings in the relevant field of art, and are not to be interpreted to have idealistic or excessively formalistic meanings unless explicitly defined in the present application. Specific details for implementing the present disclosure will be described as follows.

### Carbon Nanotube-Based Self-Reinforced Composite

The present disclosure provides a self-reinforced composite comprising: a matrix comprising carbon nanotubes; and reinforcements positioned on the matrix and comprising the carbon nanotubes.

In addition, the reinforcement and the matrix of the self-reinforced composite of the present disclosure may be physically different from each other, but chemically identical to each other, and specifically, in the self-reinforced composite, the matrix may comprise a carbon nanotube film, and the reinforcement may comprise a carbon nanotube fiber.

Further, the self-reinforced composite may have a form in which a part or all of the reinforcement is impregnated into the matrix.

Besides, the carbon nanotube fiber, which is the reinforcement, may comprise ply fibers in which a plurality of carbon nanotube fibers are twisted together.

In addition, a diameter of the carbon nanotube fiber may be 1 to 80 μm, preferably 5 to 70 μm, and more preferably 10 to 60 μm. More specifically, a diameter of one carbon nanotube fiber may be 10 to 30 μm, and a diameter of the ply fiber in which the plurality of carbon nanotube fibers are twisted together may be 30 to 60 μm.

Further, the reinforcements may be randomly arranged, arranged in parallel, or arranged to cross each other while forming a constant crossing angle, on the matrix.

Specifically, when the self-reinforced composite is viewed from above, the carbon nanotube fibers may be randomly arranged, arranged in parallel, or arranged to cross each other at a certain angle, on the matrix. In this case, the expression “randomly arranged” means that the reinforcements are disorderly arranged without a predetermined direction, and the expression “arranged to cross each other” means that the reinforcements (that is, carbon nanotube fibers) are arranged with contact points (crossing point) while forming a predetermined crossing angle rather than being arranged in parallel.

In addition, when the reinforcements are arranged to cross each other, when viewed in three dimensions, all of the reinforcements of the first layer are arranged on the matrix, the reinforcement of the second layer are arranged thereon to form an angle different from that of the reinforcement of the first layer, and the reinforcement of each layer may form a specific angle (crossing angle) with the reinforcement of the adjacent layer. This allows for greater resistance to bending, twisting, and shear using an angle ply technique, thereby implementing improvements in strength and flexibility.

Further, the reinforcements may be arranged on the matrix while forming a crossing angle of 0° or greater and less than 90°, preferably 0° to 70°, more preferably 0° to 50°, still more preferably 0° to 30°, and still further more preferably 0° to 25°. In this case, the expression “arranged while forming a crossing angle of 0°” means that the reinforcements are arranged in parallel on the matrix. Specifically, a lower limit of the crossing angle may be 0° or greater, 1±0.5° or greater, 2±0.5° or greater, 3±0.5° or greater, or 4±0.5° or greater. In this case, an upper limit thereof may be less than 90°, 70±0.5° or less, 50±0.5° or less, 45±0.5° or less, 40±0.5° or less, 35±0.5° or less, 30±0.5° or less, 25±0.5° or less, 24±0.5° or less, 23±0.5° or less, 22±0.5° or less, or 21±0.5° or less.

When the crossing angle is 90° or greater, only the reinforcements cross each other, and it is difficult to improve elongation through the crossing point (contact point), which is not preferable.

In addition, a thickness of the matrix may be 10 to 100 μm, preferably 20 to 80 μm, and more preferably 30 to 70 μm.

Further, the matrix may be any one selected from the group consisting of a pristine matrix, an ultrasonicated matrix, a heat-treated matrix, and an ultrasonicated and heat-treated matrix.

The matrix may also have a specific surface area of 30 to 900 m²/g. Specifically, the pristine matrix may have a specific surface area of 30 to 100 m²/g, preferably 40 to 80 m²/g, and more preferably 50 to 60 m²/g. In addition, the ultrasonicated matrix or the heat-treated matrix may have a specific surface area of 100 to 500 m²/g, preferably 200 to 400 m²/g, and more preferably 250 to 350 m²/g. Further, the ultrasonicated and heat-treated matrix may have a specific surface area of 500 to 900 m²/g. Preferably, the ultrasonicated and heat-treated matrix may have a specific surface area of preferably 600 to 800 m²/g, and more preferably 650 to 750 m²/g. In this case, the specific surface area of the matrix is measured through BET test analysis (Micromeritics, Tristar II plus 3030) through nitrogen gas adsorption.

In addition, the carbon nanotube may comprise one or more selected from the group consisting of a single-walled carbon nanotube (SWCNT), a double-walled carbon nanotube (DWCNT), and a multi-walled carbon nanotube (MWCNT), and preferably, may comprise the single-walled carbon nanotube (SWCNT).

Further, the self-reinforced composite may have a fiber volume fraction of 0.1% to 5%, preferably 0.5% to 4%, and more preferably 1% to 3%. The term “fiber volume fraction” used herein refers to a percentage of the fiber (reinforcement) volume in the total volume of the self-reinforced composite.

In addition, the matrix may have a length of 10 to 100 mm, a width of 1 to 30 mm, and a thickness of 10 to 100 μm.

Further, the self-reinforced composite may have an elongation of 4.8% or greater and a tensile strength of 41 MPa or greater. In addition, the self-reinforced composite may have a Young's modulus of 0.9 GPa or greater and a toughness of 113 MPa or greater. In this case, mechanical properties such as elongation, tensile strength, Young's modulus, and toughness of the self-reinforced composites (SWCNTs and SRCs) are measured using a UTM (Instron, 3365) and a 1 kN load cell (Instron, 2712-041) by modifying a test method ASTM D3039, and a tensile test is performed by measuring a tensile strength under a crosshead speed condition of 2 mm/min.

Further, the self-reinforced composite may have an electrical conductivity of 1×10⁵ S/m to 15×10⁵ S/m. In addition, the self-reinforced composite may have a sheet resistance of 3×10⁻¹ Ω/sq to 15×10⁻¹ Ω/sq. In this case, the electrical conductivity and sheet resistance of the self-reinforced composites (SWCNTs and SRCs) are measured using a 4-point probe (Ossila, T2001A3).

The present disclosure relates to a self-reinforced composite comprising only carbon nanotubes, in which the self-reinforced composite has a three-dimensional hierarchical structure and has high conductivity. In addition, by removing the remaining impurities through ultrasonication and/or heat treatment, the surface area and the pore volume are increased (pore characteristics improved), and the electrical conductivity is improved. Meanwhile, carbon fiber reinforced plastic (CFRP) has high stiffness and strength, but it has a problem of reducing the design tolerance and failing to realize the full potential of a material due to sudden brittle fracture without a yield point due to linear elastic fracture stress-strain behavior. In order to improve the problem, the present disclosure improves the strength and fracture strain by arranging the reinforcements (i.e., fibers) using the angle ply technique. In addition, due to the high surface area and porous structure of the carbon nanotube self-reinforced composite according to the present disclosure, an ion and electron transfer rate of an electrode material is increased, so that the carbon nanotube self-reinforced composite may be applied to an electrochemical device such as a lithium ion capacitor (LIC) electrode.

### Method for Preparing Carbon Nanotube-Based Self-Reinforced Composite

The present disclosure provides a method for preparing a self-reinforced composite comprising: (a) preparing a matrix comprising carbon nanotubes; (b) preparing reinforcements comprising the carbon nanotubes; and (c) preparing the self-reinforced composite by positioning the reinforcements on the matrix.

Prior to Step (a), the method may comprise (a′) preparing a carbon nanotube dispersion solution.

The carbon nanotube dispersion solution may comprise: the carbon nanotubes; and a solvent comprising alkali metal and aromatic hydrocarbon.

The carbon nanotube dispersion solution may have a concentration of 0.1 mg/ml to 5 mg/ml. In general, as a carbon nanotube solution having a high concentration is used, liquid crystal properties may be easily implemented, but when the preparing method according to the present disclosure is used, liquid crystals may be formed with only a small concentration.

The carbon nanotube dispersion solution may have an atomic ratio of alkali metal and carbon of 1:4 to 1:12. When the atomic ratio of the alkali metal and the carbon is less than 1:4, nanocarbon may not be easily dissolved, and thus may be mixed with a dispersed form in which an aggregation phenomenon occurs, and when the atomic ratio exceeds 1:12, nanocarbon may be easily dissolved, but the electrical conductivity and the tensile strength may be deteriorated, and thus it may be difficult to prepare high-purity and high-concentration carbon nanotubes.

The alkali metal may comprise at least one selected from the group consisting of sodium, potassium, and a combination thereof. The alkali metal may comprise an alkali metal, a salt thereof, or both of the alkali metal and the salt, and preferably, may be a sodium metal.

The reduction of the alkali metal may form charges on the surface of carbon nanotubes, which is referred to as reduction-dissolution of the carbon nanotubes. Carbon nanotubes may be individualized and separated without damage through reduction-dissolution of the carbon nanotubes by the alkali metal.

Specifically, referring to FIG. 1, the carbon nanotube dispersion solution is prepared by stirring sodium and naphthalene in N,N-dimethylacetamide (DMAc) and reducing sodium naphthalenide (NaNp). When a sodium ingot is dissolved in DMAc in the presence of naphthalene, dissolved electrons are formed, and sodium cation is transferred to SWCNTs. When the carbon nanotubes are added to a solvent in which sodium metal and naphthalene are dissolved, negative (−) charges may be aligned on the surface of the carbon nanotubes. Since a work function of the single-walled carbon nanotube (SWCNT) is approximately between 4 to 5 eV and is positioned relatively higher than the level of alkali metal ion, electrons of the carbon nanotube may be transferred to the solvent comprising the alkali metal. This can be seen as an effect of doping holes of the carbon nanotubes, and thus the advantage of increasing the electrical conductivity of the carbon nanotubes may be obtained simultaneously. The sodium cations may induce electrostatic repulsion between SWCNTs with the help of naphthalene, dissolve SWCNTs in DMAc, and separate nanotubides individually. This is a dispersion method in which anions of CNTs selectively react and dissolve in an organic solvent.

The aromatic hydrocarbon may comprise naphthalene.

The naphthalene may react with the alkali metal in the solvent to have a form of a metal salt in which the alkali metal is positively charged and the naphthalene is negatively charged. The aromatic hydrocarbon in the form of a metal salt has electric charges to enable solvation, and thus the charges are oriented on the surface of the carbon nanotube so that the carbon nanotubes themselves may be dissolved. The aromatic hydrocarbon in the form of a metal salt may be preferably obtained by the reaction of sodium metal and naphthalene, and the sodium metal and naphthalene may cause an initiation reaction due to electron transfer to act as an anionic initiator. In this case, the anion initiator may react with the carbon nanotubes to cause an anion initiation reaction of generating carbon anions.

The solvent may comprise at least one selected from the group consisting of N,N-dimethylacetamide (DMAc), tetrahydrofuran (THF), dimethyl formamide (DMF), and 1-methyl-2-pyrrolidone (NMP).

In addition, Step (a) may comprise: (a-1) preparing a substrate on which a position where the reinforcements are to be arranged is marked; and (a-2) preparing the matrix comprising the carbon nanotubes by casting a carbon nanotube dispersion solution on the substrate. As used herein, the term “casting” refers to a process of pouring a liquid material into a mold having a cavity with a desired shape.

In Step (a-2), the casting may be performed using a bar coating method.

Specifically, Step (a-2) may be a step of preparing a matrix by pouring the carbon nanotube dispersion solution onto the substrate and applying the same, and adjusting an application thickness using a doctor blade, followed by drying.

Further, after Step (a-2), the method may further comprise (a-3) preparing an ultrasonicated matrix by ultrasonicating the matrix in a solution containing one or more selected from the group consisting of sulfuric acid, toluene, and distilled water.

In addition, after Step (a-3), the method may further comprise (a-4) preparing an ultrasonicated and heat-treated matrix by heat-treating the ultrasonicated matrix at a temperature of 300° C. to 700° C.

Furthermore, Step (b) may be a step of preparing a reinforcement by wet-spinning the carbon nanotube dispersion solution. The reinforcement may be prepared in a continuous shape of several tens of meters of unit material through wet-spinning, and may be implemented in various shapes.

In addition, Step (c) may be a step of preparing a self-reinforced composite by arranging the reinforcements on the matrix at a position indicated on the substrate.

Further, the reinforcements may be arranged while forming a crossing angle of 0° or greater and less than 90° on the matrix, preferably 0° to 70°, more preferably 0° to 50°, still more preferably 0° to 30°, and still further more preferably 0° to 25°. In this case, the expression “arranged while forming a crossing angle of 0°” means that the reinforcements are arranged in parallel on the matrix.

Specifically, a lower limit of the crossing angle may be 0° or greater, 1±0.5° or greater, 2±0.5° or greater, 3±0.5° or greater, or 4±0.5° or greater. In this case, an upper limit may be less than 90°, 70±0.5° or less, 50±0.5° or less, 45±0.5° or less, 40±0.5° or less, 35±0.5° or less, 30±0.5° or less, 25±0.5° or less, 24±0.5° or less, 23±0.5° or less, 22±0.5° or less, or 21±0.5° or less.

### Electrode for Electrochemical Device

The present disclosure provides an electrode for an electrochemical device comprising the self-reinforced composite.

In addition, the electrode for an electrochemical device may be any one selected from the group consisting of an electrode for a primary battery, an electrode for a secondary battery, an electrode for a fuel cell, an electrode for a solar cell, and an electrode for a capacitor, and preferably, may be the electrode for a capacitor.

The self-reinforced composite of the present disclosure has a porous structure having a high surface area, so that it is possible to implement excellent charging/discharging rate and stability in the electrochemical device (capacitor, etc.), thereby obtaining excellent energy storage performance.

### Advantageous Effects

The carbon nanotube-based self-reinforced composite of the present disclosure may have high ductility and excellent electrical conductivity. In addition, the reinforcements may be arranged to cross each other, which enables a nonlinear S-S curve behavior to be achieved while suppressing damage mechanisms that cause early failure, thereby improving strength and fracture strain.

Further, the carbon nanotube-based self-reinforced composite of the present disclosure may be applied to various electrochemical devices such as supercapacitor electrodes.

### DESCRIPTION OF DRAWINGS

FIG. 1 is a schematic view showing a method for preparing a carbon nanotube dispersion solution.

FIG. 2 is a photograph of a carbon nanotube dispersion solution according to Preparation Example 1-1.

FIG. 3 is a schematic view showing a method for preparing a carbon nanotube fiber.

FIG. 4 is a schematic view showing a method for preparing a self-reinforced composite.

FIG. 5 is a photograph of a self-reinforced composite according to Example 4-3.

FIG. 6 is a polarization microscope photograph of the carbon nanotube dispersion solution according to Preparation Example 1-1.

FIG. 7 is an SEM image of a carbon nanotube fiber according to Preparation Example 2-1.

FIG. 8 is a photograph and an SEM image of a carbon nanotube film according to Preparation Example 3-1.

FIG. 9 is a view showing an arrangement structure of self-reinforced composites according to Examples 1-1 to 1-5.

FIG. 10 is a histogram showing crossing angles of the self-reinforced composites according to Examples 1-2 to 1-5.

FIG. 11 is an image of confirming a surface and a cross-section of a self-reinforced composite according to the present disclosure.

FIG. 12 is a graph showing mechanical properties (elongation, tensile strength, Young's modulus, toughness) of Comparative Example 1 and Examples 1-1 to 1-5.

FIG. 13 is a graph showing comparison of an S-S curve and elongation, tensile strength, and pseudo-ductility of Comparative Example 1 and Examples 1-1 to 1-5.

FIG. 14 is an SEM image of carbon nanotube films according to Preparation Examples 3-1 to 3-3.

FIG. 15 is an SEM-EDS image of the carbon nanotube films according to Preparation Examples 3-1 to 3-3.

FIG. 16 is a nitrogen absorption/desorption curve of the carbon nanotube films according to Preparation Examples 3-1 to 3-3.

FIG. 17 is a graph showing comparison of an electrical conductivity and sheet resistance of SWCNTs and SRCs according to Examples 1-1 to 1-5, 2-1 to 2-5, and 3-1 to 3-5 and films according to Comparative Examples 1 to 3. In this case, a unit of the sheet resistance is expressed as Ω/□(=Ω/sq).

FIG. 18 is a C-V curve and an EIS Nyquist plot graph of the SWCNTs and the SRCs according to Examples 1-1 to 1-4 and the films according to Comparative Examples 1 to 3.

### BEST MODE

The following Examples are presented to help understanding of the present disclosure. The following exemplary embodiments are only provided to more easily understand the present disclosure, but the content of the present disclosure is not limited by these Examples.

### EXAMPLES

### Preparation Example 1 Preparation of Carbon Nanotube (SWCNT) Dispersion Solution

### Preparation Example 1-1: Preparation of Carbon Nanotube (SWCNT) Dispersion Solution

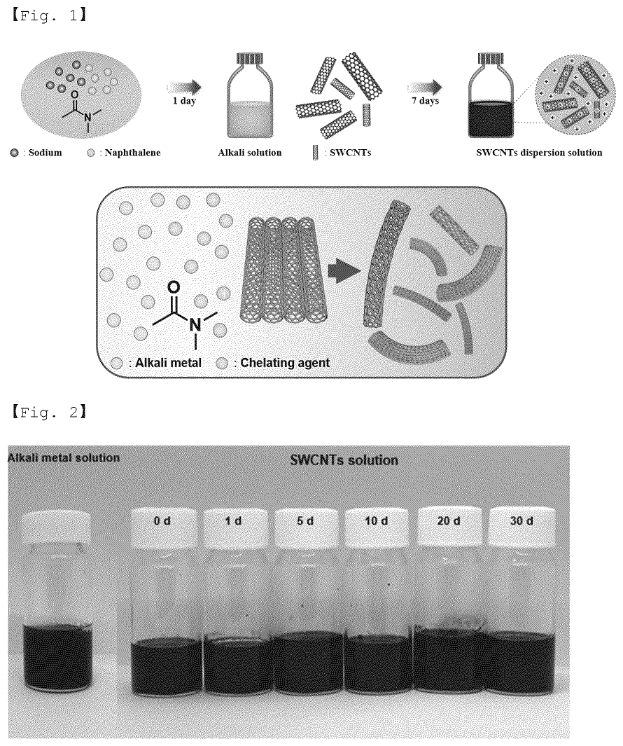

As shown in FIG. 1, sodium naphthalenide (NaNp) was prepared by stirring 99.95% (6.39 mg) of sodium ingot and naphthalene (35.58 mg) in N,N-dimethylacetamide (DMAc, 6.39 mL) at 300 rpm for 1 day in a nitrogen glove box. Thereafter, SWCNTs (eDIPS-MEIJO), from which impurities were removed using a furnace at 500° C. for 3 hours, were added, and stirred at 300 rpm for 7 days to dissolve the same, thereby individually separating nanotubides. Finally, 2 mg/mL of a liquid crystalline carbon nanotube dispersion solution having an atomic ratio of alkali metal (sodium) and carbon of 1:6 was prepared. In FIG. 2, a photograph of the carbon nanotube dispersion solution prepared according to Preparation Example 1-1 may be confirmed.

### Preparation Example 1-2: Preparation of Dispersion Solution Having Different Manufacturer

A dispersion solution was prepared in the same manner as in Preparation Example 1-1, except that SWCNTs (OCSiAl, Tuball) were used instead of SWCNTs (eDIPS-MEIJO).

### Preparation Example 2 Preparation of Carbon Nanotube (SWCNT) Fibers

### Preparation Example 2-1: Preparation of Carbon Nanotube (SWCNT) Fibers

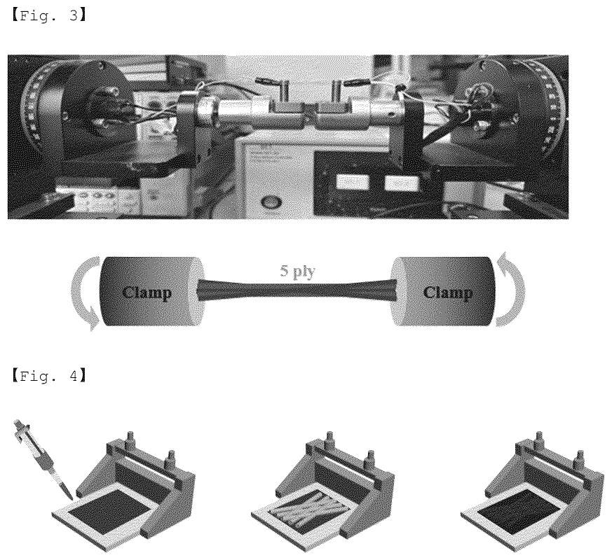

The SWCNT dispersion solution according to Preparation Example 1-1 was centrifuged under a condition of 10000 g for 40 minutes, and a supernatant was used as a spinning solution. The spinning solution was placed in a 5 mL disposable syringe, and spun at a condition of 5 mL/min using a blunt type (23 gauge) needle, ethanol serving as a coagulation bath, and a syringe pump. The coagulation bath was rotated at 30 rpm to impart a shear force. As shown in FIG. 3, 5 strands of filaments were stacked in parallel on clamps at both ends, and twisted by bidirectional rotation (20 twists/cm) to prepare carbon nanotube (SWCNT) fibers (5 ply).

### Preparation Example 2-2: Preparation of Carbon Nanotube (SWCNT) Fibers Having Different Manufacturers

A carbon nanotube (SWCNT) fiber was prepared in the same manner as in Preparation Example 2-1, except that the SWCNT dispersion solution according to Preparation Example 1-2 was used instead of the SWCNT dispersion solution according to Preparation Example 1-1.

### Preparation Example 3 Preparation of Carbon Nanotube (SWCNT) Film

### Preparation Example 3-1: Preparation of SWCNT Film (C Matrix)

A double-sided tape was attached to a pure glass plate, and a PTFE Teflon sheet (Tommyheco) was attached thereto and used as a substrate. The SWCNT dispersion solution according to Preparation Example 1-1 was cast on the substrate in the nitrogen glove box using a doctor blade and dried for 1 day. Thereafter, the resultant was removed from the substrate to prepare a carbon nanotube film (C matrix).

### Preparation Example 3-2: Preparation of SWCNT Film (C/S Matrix)

The film prepared according to Preparation Example 3-1 was ultrasonicated with a solution obtained by diluting sulfuric acid and distilled water at a ratio of 1:3 at room temperature for 30 minutes, was ultrasonicated with a solution obtained by diluting toluene and distilled water at a ratio of 1:1 at room temperature for 30 minutes, and was finally ultrasonicated with distilled water at room temperature for 30 minutes to prepare an ultrasonicated carbon nanotube film (C/S matrix). In this case, sulfuric acid was used to dissolve sodium, toluene was used to dissolve naphthalene, and distilled water was used to remove residual sulfuric acid and toluene.

### Preparation Example 3-3: Preparation of SWCNT Film (C/S/H Matrix)

The film prepared according to Preparation Example 3-2 was heat-treated at 500° C. for 3 hours to prepare an ultrasonicated and heat-treated carbon nanotube film (C/S/H matrix).

### Preparation Example 3-4: Preparation of SWCNT Film Having Different Manufacturer

A carbon nanotube film was prepared in the same manner as in Preparation Example 3-1, except that the SWCNT dispersion solution according to Preparation Example 1-2 was used instead of the SWCNT dispersion solution according to Preparation Example 1-1.

### Preparation of Carbon Nanotube Self-Reinforced Composites (SWCNTs and SRCs)

### Example 1: Using C Matrix

### Example 1-1: Preparation of SWCNTs and SRCs Having Crossing Angle of 0°

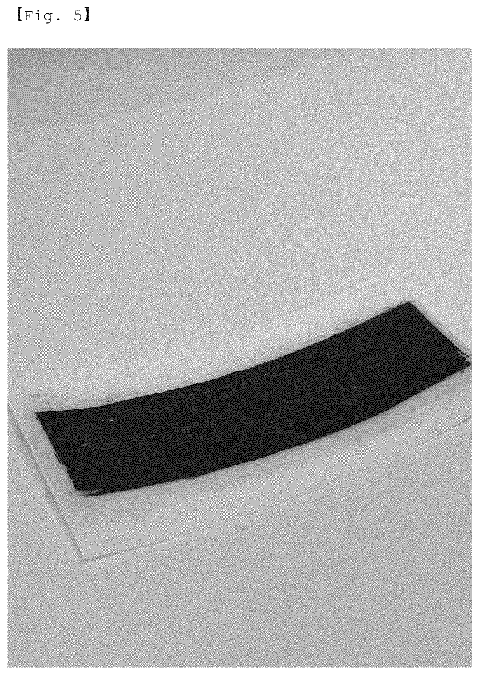

A double-sided tape was attached to a pure glass plate, and a PTFE Teflon sheet (Tommyheco) was attached thereto and used as a substrate. As shown in FIG. 4, a position was marked on the substrate according to an angle at which the fibers (reinforcements) were to be arranged, and the substrate was put into a glove box. In this case, the position was marked such that the crossing angle of the fibers was 0°, that is, the fibers were arranged in parallel.

Thereafter, the SWCNT dispersion solution prepared according to Preparation Example 1-1 was cast primarily using a doctor blade, and dried for 1 day to prepare a matrix including a carbon nanotube (SWCNT) film (C matrix).

Next, the SWCNT dispersion solution prepared according to Preparation Example 1-1 was cast on the matrix (C matrix) in the same manner, and the SWCNT fibers (5 ply) prepared according to Preparation Example 2-1 were arranged in a pre-marked position in an undried state, and dried for 1 day. Thereafter, the resultant was removed from the substrate to prepare a carbon nanotube self-reinforced composite.

### Example 1-2: Preparation of SWCNTs and SRCs Having Crossing Angle of 5°

A carbon nanotube self-reinforced composite was prepared in the same manner as in Example 1-1, except that the position was marked such that the fiber had a crossing angle of 5° instead of 0°.

### Example 1-3: Preparation of SWCNTs and SRCs Having Crossing Angle of 10°

A carbon nanotube self-reinforced composite was prepared in the same manner as in Example 1-1, except that the position was marked such that the fiber had a crossing angle of 10° instead of 0°.

### Example 1-4: Preparation of SWCNTs and SRCs Having Crossing Angle of 15°

A carbon nanotube self-reinforced composite was prepared in the same manner as in Example 1-1, except that the position was marked such that the fiber had a crossing angle of 15° instead of 0°.

### Example 1-5: Preparation of SWCNTs and SRCs Having Crossing Angle of 20°

A carbon nanotube self-reinforced composite was prepared in the same manner as in Example 1-1, except that the position was marked such that the fiber had a crossing angle of 20° instead of 0°.

### Example 2: Using C/S Matrix

### Example 2-1: Preparation of SWCNTs and SRCs Having Crossing Angle of 0°

A double-sided tape was attached to a pure glass plate, and a PTFE Teflon sheet (Tommyheco) was attached thereto and used as a substrate. As shown in FIG. 4, a position was marked on the substrate according to an angle at which the fibers (reinforcements) were arranged, and the substrate was put into a glove box. In this case, the position was marked such that the crossing angle of the fibers was 0°, that is, the fibers were arranged in parallel.

Thereafter, the SWCNT dispersion solution prepared according to Preparation Example 1-1 was cast primarily using a doctor blade, and dried for 1 day. In addition, the resultant was ultrasonicated with a solution obtained by diluting sulfuric acid and distilled water at a ratio of 1:3 at room temperature for 30 minutes, was ultrasonicated with a solution obtained by diluting toluene and distilled water at a ratio of 1:1 at room temperature for 30 minutes, and was finally ultrasonicated with distilled water at room temperature for 30 minutes to prepare a matrix including a carbon nanotube (SWCNT) film (C/S matrix).

Next, the SWCNT dispersion solution prepared according to Preparation Example 1-1 was cast on the matrix (C/S matrix) in the same manner, and the SWCNT fibers (5 ply) prepared according to Preparation Example 2-1 were arranged in a pre-marked position in an undried state, and dried for 1 day. Thereafter, the resultant was removed from the substrate to prepare a carbon nanotube self-reinforced composite.

### Examples 2-2 to 2-5: Preparation of SWCNTs and SRCs Having Crossing Angle of 5° to 20°

Each carbon nanotube self-reinforced composite was prepared in the same manner as in Example 2-1, except that the crossing angles of the fibers are 5°, 10°, 15°, and 20°, respectively, instead of 0°.

### Example 3: Using C/S/H matrix

### Example 3-1: Preparation of SWCNTs and SRCs Having Crossing Angle of 0°

A double-sided tape was attached to a pure glass plate, and a PTFE Teflon sheet (Tommyheco) was attached thereto and used as a substrate. As shown in FIG. 4, a position was marked on the substrate according to an angle at which the fibers (reinforcements) were arranged, and the substrate was put into a glove box. In this case, the position was marked such that the crossing angle of the fibers was 0°, that is, the fibers were arranged in parallel.

Thereafter, the SWCNT dispersion solution prepared according to Preparation Example 1-1 was cast primarily using a doctor blade, and dried for 1 day. In addition, the resultant was ultrasonicated with a solution obtained by diluting sulfuric acid and distilled water at a ratio of 1:3 at room temperature for 30 minutes, was ultrasonicated with a solution obtained by diluting toluene and distilled water at a ratio of 1:1 at room temperature for 30 minutes, and was finally ultrasonicated with distilled water at room temperature for 30 minutes. After ultrasonication, heat treatment was performed at 500° C. for 3 hours to prepare a matrix including a carbon nanotube (SWCNT) film (C/S/H matrix).

Next, the SWCNT dispersion solution prepared according to Preparation Example 1-1 was cast on the matrix (C/S/H matrix) in the same manner, and the SWCNT fibers (5 ply) prepared according to Preparation Example 2-1 were arranged in a pre-marked position in an undried state, and dried for 1 day. Thereafter, the resultant was removed from the substrate to prepare a carbon nanotube self-reinforced composite.

### Examples 3-2 to 3-5: Preparation of SWCNTs and SRCs Having Crossing Angle of 5° to 20°

Each carbon nanotube self-reinforced composite was prepared in the same manner as in Example 3-1, except that the crossing angles of the fibers are 5°, 10°, 15°, and 20°, respectively, instead of 0°.

### Example 4: Preparation of SWCNTs and SRCs Having Different Manufacturers

### Examples 4-1 to 4-5: Preparation of SWCNTs and SRCs Having Crossing Angle of 0° to 20°

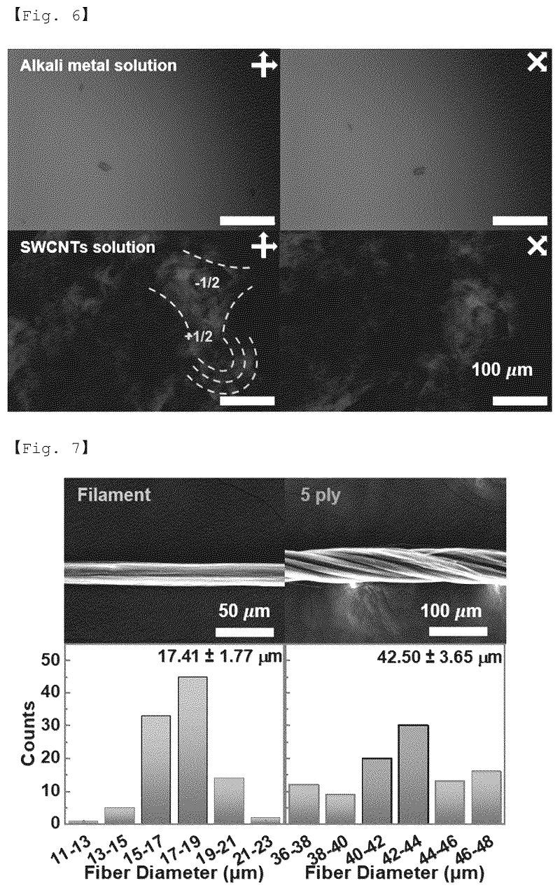

Each carbon nanotube self-reinforced composite was prepared in the same manner as in Examples 1-1 to 1-5, except that the SWCNT dispersion solution prepared according to Preparation Example 1-2 and the SWCNT fiber prepared according to Preparation Example 2-2 were used instead of the SWCNT dispersion solution prepared according to Preparation Example 1-1 and the SWCNT fiber prepared according to Preparation Example 2-1. In this case, in FIG. 5, a photograph of a self-reinforced composite according to Example 4-3 may be confirmed.

### Comparative Example 1: Preparation of Film

A film prepared according to Preparation Example 3-1 was used as Comparative Example 1.

### Comparative Example 2: Preparation of Film

A film prepared according to Preparation Example 3-2 was used as Comparative Example 2.

### Comparative Example 3: Preparation of Film

A film prepared according to Preparation Example 3-3 was used as Comparative Example 3.

The configurations of the self-reinforced composites according to Examples 1-1 to 4-5 and the films according to Comparative Examples 1 to 3 are specifically described in the following Table 1.

TABLE 1

| | Carbon | | | |
|---|---|---|---|---|
| | nanotube | | | |
| Classifi- | dispersion | Matrix | Reinforcement | Crossing |
| cation | solution | (Film) | (Fiber) | angle |
| Example 1-1 | Preparation | C matrix | Preparation | 0° |
| Example 1-2 | Example 1-1 | | Example 2-1 | 5° |
| Example 1-3 | | | | 10° |
| Example 1-4 | | | | 15° |
| Example 1-5 | | | | 20° |
| Example 2-1 | Preparation | C/S matrix | | 0° |
| Example 2-2 | Example 1-1 | | | 5° |
| Example 2-3 | | | | 10° |
| Example 2-4 | | | | 15° |
| Example 2-5 | | | | 20° |
| Example 3-1 | Preparation | C/S/H matrix | | 0° |
| Example 3-2 | Example 1-1 | | | 5° |
| Example 3-3 | | | | 10° |
| Example 3-4 | | | | 15° |
| Example 3-5 | | | | 20° |
| Example 4-1 | Preparation | C matrix | Preparation | 0° |
| Example 4-2 | Example 1-2 | | Example 2-2 | 5° |
| Example 4-3 | | | | 10° |
| Example 4-4 | | | | 15° |
| Example 4-5 | | | | 20° |
| Comparative | Preparation | Preparation | — | — |
| Example 1 | Example 1-1 | Example 3-1 | | |
| | | (C matrix) | | |
| Comparative | Preparation | Preparation | — | — |
| Example 2 | Example 1-1 | Example 3-2 | | |
| | | (C/S matrix) | | |
| Comparative | Preparation | Preparation | — | — |
| Example 3 | Example 1-1 | Example 3-3 | | |
| | | (C/S/H matrix) | | |

### Experimental Examples

### Experimental Example 1: Evaluation of Liquid Crystal Properties of Dispersion Solution

In order to confirm liquid crystal properties of the carbon nanotube dispersion solution according to Preparation Example 1-1, a polarization microscope photograph was taken to observe the carbon nanotube dispersion solution. Specifically, a polarization microscope (Nikon, Eclipse Ci POL) was used to analyze the liquid crystal properties of the SWCNT dispersion solution. In order to prevent contact with an external environment such as O₂ and H₂O, the solution was sealed using a slide glass and a cover glass in a glove box, and the analysis thereof was performed. The results are shown in FIG. 6.

According to FIG. 6, it was confirmed that the carbon nanotube dispersion solution prepared according to Preparation Example 1-1 had sufficient liquid crystal properties through the confirmation of disclination of +½ and −½, which is typically shown in the liquid crystal properties arranged in two dimensions.

### Experimental Example 2: Evaluation of Morphological Properties of Fibers and Films

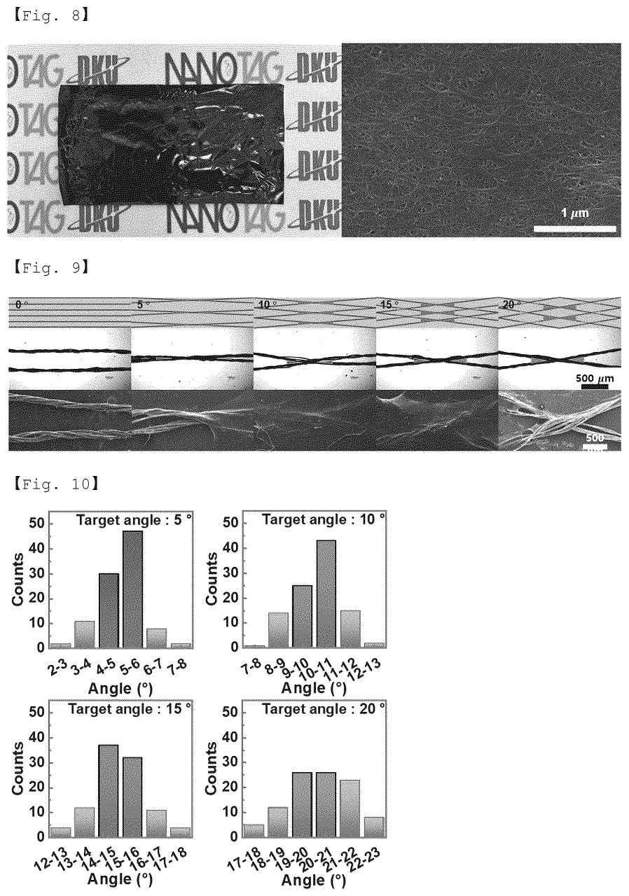

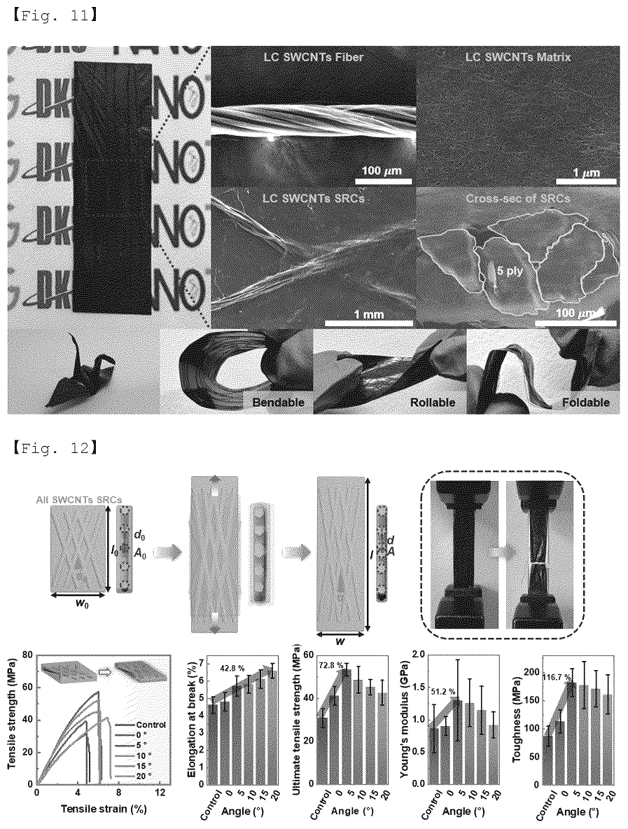

In order to observe a surface and cross-sectional shape of SWCNT filament and 5 ply according to Preparation Example 2-1, a scanning electron microscopy (SEM, SERON, AIS2000C) was used. An average diameter of filament and 5 ply was calculated through diameter analysis of a total of 100 specimens. Similarly, the surface and cross-sectional shape of the SWCNT film (matrix) according to Preparation Example 3-1 were observed using SEM, and a thickness thereof was calculated. The results are shown in FIGS. 7 and 8.

According to FIG. 7, the average diameter of the SWCNT filament according to Preparation Example 2-1 was 17.41±1.77 μm, and the average diameter of the 5 ply fibers was 42.50±3.65 μm.

In addition, according to FIG. 8, the carbon nanotube film according to Preparation Example 3-1 had a thickness of 51.94+7.77 μm.

### Experimental Example 3: Evaluation of Morphological Properties of Self-Reinforced Composite

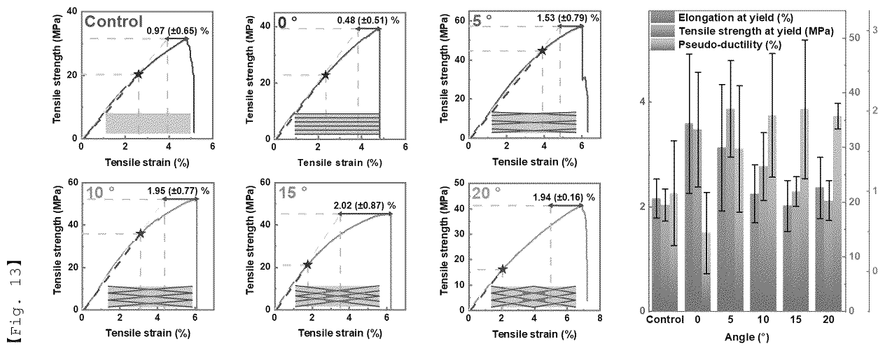

Crossing angles of the reinforcements in the SWCNTs and SRCs prepared according to Examples 1-1 to 1-5 were confirmed using an optical microscope (OM, Nikon, Eclipse Ci POL), and the results are shown in FIG. 9. In addition, angles of a total of 100 specimens were measured using an electronic protractor and shown as a histogram, and the results are shown in FIG. 10 and Table 2.

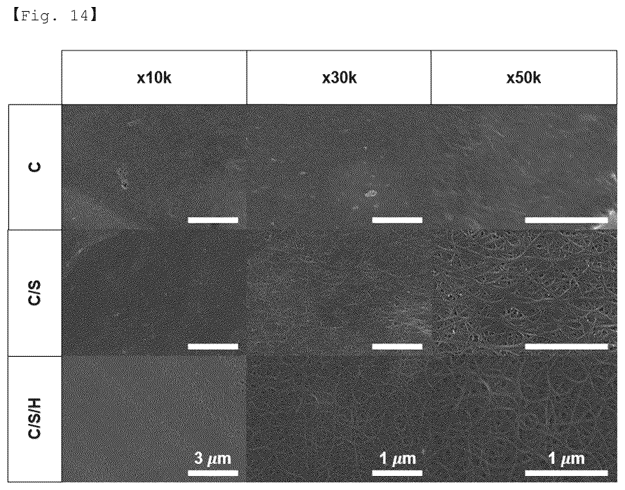

In addition, the surface and cross-sectional shape of the SWCNTs and SRCs prepared according to Examples 1-1 to 1-5 were observed using a field emission scanning electron microscope (FE-SEM, Hitachi, S-4700 and S-5200, 5 kV), and the results are shown in FIG. 11.

TABLE 2

| | | | | | Fiber |
|---|---|---|---|---|---|
| Target | Measured | Gauge | | | volume |
| angle | angle | length | Width | Thickness | fraction |
| (°) | (°) | (mm) | (mm) | (μm) | (%) |
| Comparative | — | 60 | 15 | 51.94 ± 7.77 | — |
| Example 1 | | | | | |
| (Control) | | | | | |
| Example 1-1 | — | 60 | 15 | 46.88 ± 5.70 | 1.73 |
| (0°) | | | | | |
| Example 1-2 | 4.92 ± 0.89 | 60 | 15 | 46.90 ± 6.24 | 1.73 |
| (5°) | | | | | |
| Example 1-3 | 10.03 ± 0.99 | 60 | 15 | 45.98 ± 6.99 | 1.77 |
| (10°) | | | | | |
| Example 1-4 | 14.88 ± 1.08 | 60 | 15 | 46.11 ± 9.37 | 1.93 |
| (15°) | | | | | |
| Example 1-5 | 20.11 ± 1.26 | 60 | 15 | 43.84 ± 9.66 | 2.24 |
| (20°) | | | | | |

According to FIGS. 9 and 10 and Table 2, in the SWCNTs and SRCs prepared according to Examples 1-1 to 1-5, a measurement value of the crossing angle of the reinforcement (carbon nanotube fiber) showed a result value similar to the target angle.

In addition, according to FIG. 11, it was confirmed that a liquid crystalline SWCNT fiber (reinforcement) was prepared through a wet spinning process, and a SWCNT film (matrix) was prepared through film casting. In addition, it was confirmed that the reinforcement and the matrix are formed of the same material, so that interfacial resistance is minimized, and the reinforcement and the matrix are entangled with each other, thereby obtaining good interaction therebetween. In addition, it was confirmed through an image of cross-sec that the 5 ply fibers were well positioned inside the self-reinforced composite (SRC). In addition, it was confirmed that the self-reinforced composite may be applied in a free form while improving morphological resistance to bending, folding, and rolling without damage. This means that strength and flexibility are improved due to an angle ply technique.

Therefore, it was found that the SWCNT self-reinforced composites prepared according to Examples 1-1 to 1-5 were well prepared.

### Experimental Example 4: Evaluation of Mechanical Properties of Self-Reinforced Composites (SWCNTs and SRCs)

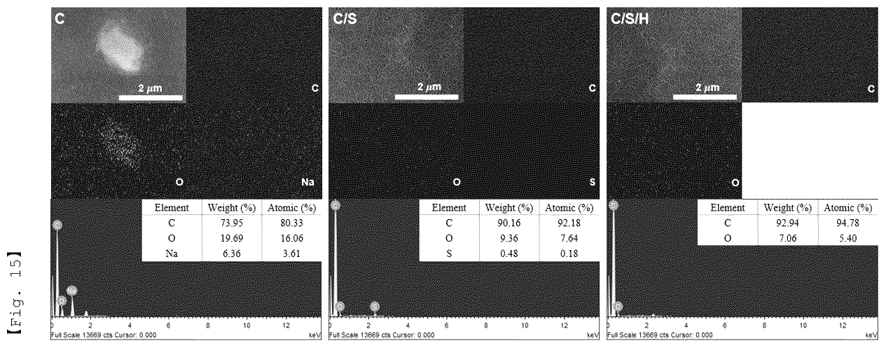

In order to measure mechanical properties of the SWCNTs and SRCs according to Examples 1-1 to 1-5, a specimen was manufactured to have a gauge length of 60 mm and a width of 15 mm, and both ends of the specimen were fixed with epoxy to prevent slipping. The mechanical properties of the SWCNTs and SRCs were measured using a UTM (Instron, 3365) and a 1 kN load cell (Instron, 2712-041) by modifying a test method ASTM D3039, and a tensile test was performed by measuring a tensile strength under a crosshead speed condition of 2 mm/min. The results are shown in FIGS. 12 and 13.

According to FIG. 12, the mechanical properties of the SRCs of Examples 1-1 to 1-5 including the reinforcement were overall improved compared to a control group (control, Comparative Example 1) without the reinforcement. First, in the case of elongation, as the crossing angle increased, the length of the fiber increased, and the fiber volume fraction increased, resulting in an increase in elongation. The results were encouraging in that the elongation of SRCs of Examples 1-1 to 1-5 including the reinforcement increased by about 42.8% compared to the control group (control, Comparative Example 1) without the reinforcement. Second, as the crossing angle increased, the fiber volume fraction increased, and the number of contact points between fibers increased, thereby increasing the fine frictional force. As a result, the interfacial resistance at the contact point also increased, and the tensile strength and Young's modulus increased by 72.8% and 51.2%, respectively, compared to the control group (control, Comparative Example 1) without the reinforcement. This means that the mechanical properties of the self-reinforced composite according to the present disclosure are significantly increased compared to the control group without the reinforcement, and thus the reinforcement serves as a sufficient framework in the SWCNTs and SRCs according to the present disclosure. Such a portion had a significant effect on cutting-off energy during the tensile test of SWCNTs and SRCs, and the toughness of Example 1-2 (crossing angle of) 5° was improved by 116.7% compared to the control group (control, Comparative Example 1), so that it was found that when the reinforcement was included, the cutting-off energy was further required. As a result, it was analyzed that the fiber volume fraction of the self-reinforced composite according to the present disclosure is only about 1% to 2%, but the fiber, that is, the reinforcement sufficiently serves as a frame.

In addition, according to FIG. 13, pseudo-ductility is a concept that mechanical energy may be absorbed even after the reinforcement is fractured by adjusting the fine frictional force through an angle ply in which the crossing angle between the reinforcements is adjusted. As for the pseudo-ductility, a point where an initial slope value and a value interfered by 0.1% of the slope value meet at an S-S curve is called a yield point, and a difference between a theoretical fracture strain and a fracture strain upon actual fracture is designated as the pseudo-ductility value by continuing the initial slope. The control group (control, Comparative Example 1) had a constrained value of less than 1%, and it could be seen that a pseudo-ductility value gradually increased as the crossing angle increased.

Specifically, when comparing the control group (Comparative Example 1) with Example 1-1 (crossing angle of) 0°, Example 1-1 in which the reinforcements were arranged in one direction had no effect on pseudo-ductility, but had significant effect on the tensile strength. When comparing Example 1-1 (crossing angle of) 0° having no contact point between the reinforcements with Example 1-2 (crossing angle of) 5° having three contact points, the effect of the frictional force between the fibers (reinforcements) was clearly present at the contact point, resulting in a significant increase in pseudo-ductility. In the case of Examples 1-2 (crossing angle of) 5° and Examples 1-3 (crossing angle of) 10°, there were the same three contact points in the same manner, but an angle of the contact point (crossing point) of Examples 1-3 (crossing angle of) 10° was larger, so that the pseudo-ductility increased. Next, Examples 1-3 (crossing angle of) 10° and Examples 1˜4 (crossing angle of) 15° had the same three contact points at the center (orange portion), but in the case of Example 1-4 (crossing angle of) 15°, another contact point of a side portion (blue portion) was generated. The total number of contact points increased, resulting in greater pseudo-ductility of Example 1-4 (crossing angle of) 15° compared to Example 1-3 (crossing angle of) 10°. Finally, in Example 1-5 (crossing angle of) 20°, there were two contact points at the center (orange portion), but the contact points on a side (blue portion) were the most at six. When comparing Example 1-3 (crossing angle of) 10° with Example 1-5 (crossing angle of) 20°, it was found that the contact points of Example 1-3 (crossing angle of) 10° were three and the contact points of Example 1-5 (crossing angle of) 20° were two, but the pseudo-ductility was almost similar due to the six contact points on the side.

Therefore, in the self-reinforced composite Example 1-4 (crossing angle of) 15°, pseudo-ductility of 2.02% was achieved, and it is interpreted that the higher the number of contact points between the reinforcements, the larger the crossing angle of the contact points, and the larger the number of contact points on the side as well as the contact point at the center, the higher the fracture strain than the original fracture strain may be obtained.

### Experimental Example 5: Analysis of Surface Morphology of Film Depending on Impurity Treatment

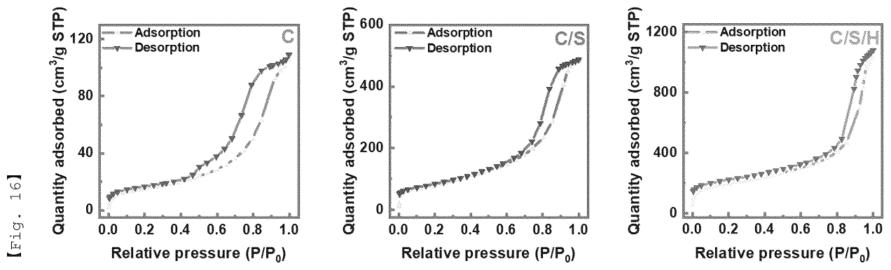

The surface and cross-sectional shape of the SWCNT films (matrix) according to Preparation Examples 3-1 to 3-3 are observed using SEM, and the results are shown in FIG. 14. Elements were detected by scanning electron microscopy-energy dispersive X-ray spectroscopy (SEM-EDS, Hitachi s-4700) analysis, and mapping images thereof are shown in FIG. 15.

According to FIGS. 14 and 15, it was confirmed that Na and Np impurities obtained in a reductive dissolution process blocked pores of the surface of C matrix (Preparation Example 3-1) without any treatment. Most of impurities of the C/S matrix (Preparation Example 3-2), which was ultrasonicated to remove Na and Np, were removed, but a trace amount of sulfur was detected. It was confirmed that the remaining impurities were removed from the C/S/H matrix (Preparation Example 3-3) that was heat-treated in order to remove a trace amount of sulfur, and unstable amorphous was removed therefrom. Therefore, it was possible to remove impurities (sodium, naphthalene, remaining sulfuric acid or toluene, sulfur, and the like) caused in the reductive dissolution process while interfering with conductivity and pore properties through ultrasonication and/or heat treatment using sulfuric acid and toluene.

### Experimental Example 6: Evaluation of Pore Properties of Film Depending on Impurity Treatment

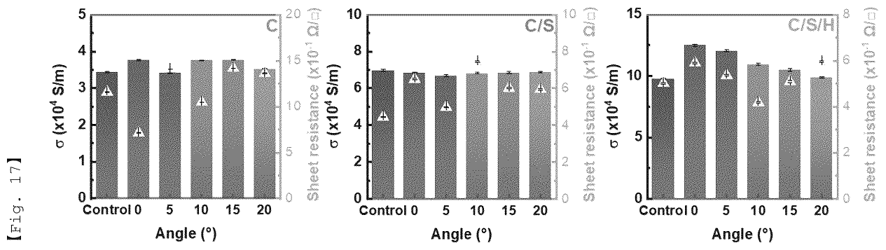

In order to analyze pore properties of the films according to Preparation Examples 3-1 to 3-3, BET test analysis (Micromeritics, Tristar II plus 3030) was performed through nitrogen gas adsorption. The results are shown in FIG. 16 and Table 3.

TABLE 3

| | Preparation | Preparation | Preparation |
|---|---|---|---|
| | Example 3-1 | Example 3-2 | Example 3-3 |
| Sample | (C) | (C/S) | (C/S/H) |
| Surface area | 55.64 (±0.20) | 293.59 (±0.61) | 707.19 (±1.40) |
| (m²/g) | | | |
| Pore volume | 0.17 | 0.75 | 1.65 |
| (cm³/g) | | | |
| Pore size (nm) | 11.83 | 10.18 | 9.31 |

According to FIG. 16 and Table 3, the surface area of Preparation Example 3-3 increased 12.7 times and the pore volume increased 9.7 times compared to Preparation Example 3-1. In addition, the nitrogen adsorption and desorption curve shows the characteristic mesoporous graph shape of type 4. Micropores of 2 nm or less confine electrolyte ions and provide a sufficient active site for storing energy, and mesopores and macropores of 2 nm or greater may serve as channels for ion diffusion during high-speed charging/discharging. An ion and electron transfer rate of an electrode material is an important factor affecting energy storage performance, and a porous structure of a carbon material having a high surface area is required, and formation of various pores in capacitor performance may be advantageous in terms of obtaining a charging/discharging rate and stability. That is, since the formation of various pores in the capacitor performance is advantageous in terms of obtaining a charging/discharging rate and stability, it was found that the self-reinforced composite according to the present disclosure is a material suitable for use as a capacitor electrode.

### Experimental Example 7: Evaluation of Electrical Properties of Self-Reinforced Composites

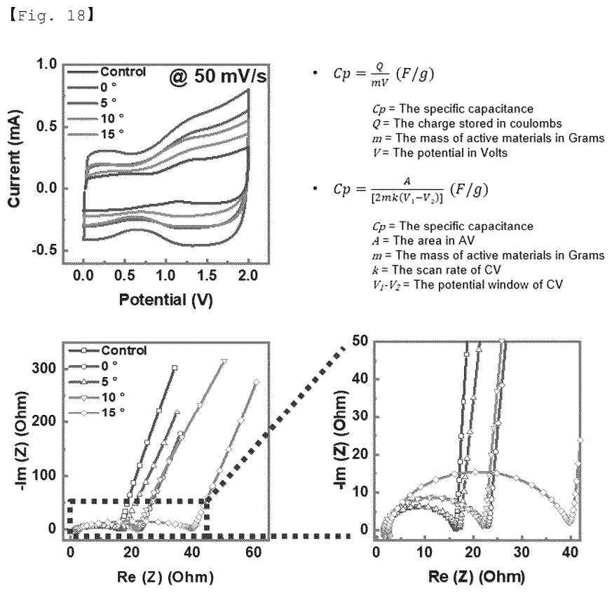

An electrical conductivity and sheet resistance of the SWCNTs and SRCs according to Examples 1-1 to 1-5, 2-1 to 2-5, and 3-1 to 3-5 and the films according to Comparative Examples 1 to 3 were measured using a four-point probe (Ossila, T2001A3). Specifically, a gauge length and a width of the SWCNTs and SRCs specimen were 60 mm and 15 mm, respectively, the electrical conductivity and sheet resistance were measured, and the results are shown in FIG. 17 and Table 4. In this case, Table 4 shows average values of the electrical conductivity and sheet resistance of the SWCNTs and SRCs according to Examples 1-1 to 1-5 and Comparative Example 1, Examples 2-1 to 2-5 and Comparative Example 2, Examples 3-1 to 3-5 and Comparative Example 3 in Examples 1 to 3, respectively. In this case, a unit of the sheet resistance is expressed as Ω/□(=Ω/sq).

TABLE 4

| | Example 1 | Example 2 | Example 3 |
|---|---|---|---|
| Sample | (C) | (C/S) | (C/S/H) |
| Electrical | 3.61 × 10⁴ | 6.87 × 10⁴ | 10.94 × 10⁴ |
| conductivity | (±0.02 × 10⁴) | (±0.05 × 10⁴) | (±0.09 × 10⁴) |
| (S/m) | | | |
| Sheet resistance | 11.84 × 10⁻¹ | 5.64 × 10⁻¹ | 5.25 × 10⁻¹ |
| (Ω/sq) | (±0.03 × 10⁻¹) | (±0.04 × 10⁻¹) | (±0.04 × 10⁻¹) |

According to FIG. 17 and Table 4, Examples 1-1 to 1-5 and Comparative Example 1 using C matrix without any treatment exhibited an average electrical conductivity of 3.61×10⁴ S/m and a sheet resistance of 11.84×10⁻¹ Ω/sq, but as the ultrasonication and heat treatment processes were further performed, the sheet resistance decreased and the electrical conductivity increased, and thus Examples 3-1 to 3-5 and Comparative Example 3 using C/S/H matrix had an average electrical conductivity of 10.94×10⁴ S/m and a sheet resistance of 5.25×10⁻¹ Ω/sq. Accordingly, it can be seen that residual by-products during the reductive dissolution process are not helpful in terms of electrical conductivity, and removing by-products is certainly helpful in terms of electrical conductivity.

### Experimental Example 8: Evaluation of Capacitance (Cp) of Self-Reinforced Composite

C-V curves and EIS Nyquist plots were measured using Potentiostat equipment, and the results are shown in FIG. 18 and Table 5. A specific capacitance (Cp) of Table 5 was calculated through the C-V curve and the following Equations 1 and 2.

$$Cp = \frac{Q}{mV} ( F / g ) \qquad [ Equation 1 ]$$

Cp=The specific capacitance
Q=The charge stored in coulombs
m=The mass of active materials in Grams
V=The potential in Volts

$$Cp = \frac{A}{[ 2 mk ( V 1 - V 2 ) ]} ( F / g ) \qquad [ Equation 2 ]$$

Cp=The specific capacitance
A=The area in AV
m=The mass of active materials in Grams
k=The scan rate of CV
V₁-V₂=The potential window of CV

TABLE 5

| Sample | Specific capacitance (F/g) |
|---|---|
| Comparative Example 1 | 3.04 |
| (Control) | |
| Example 1-1 (0°) | 8.40 |
| Example 1-2 (5°) | 6.10 |
| Example 1-3 (10°) | 4.32 |
| Example 1-4 (15°) | 5.78 |

According to FIG. 18, a current area was further improved in the self-reinforced composites according to Examples 1-1 to 1-4 compared to control (Comparative Example 1) without the reinforcement in the CV curve. This means that a current flows well when the number of electron channels is further increased through the reinforcement compared to the control group (Comparative Example 1) in which the electron channels are relatively insufficient. That is, the number of charge carriers increases and the current area expands, so that better electrochemical performance is shown. In addition, in the electrochemical impedance spectroscopy (EIS) Nyquist plot of SWCNTs and SRCs, equivalent series resistance (ESR), which is the sum of the ohmic resistances inside a semicircular capacitor, was the largest at 40 Ohm in the case of 15° (Example 1-4), and the rest showed similar ESR at about 20 Ohm. Accordingly, a portion where the charge transfer was changed was confirmed, and all Examples were conformed to have similar values except for Example 1-4.

In addition, according to Table 5, the specific capacitance (Cp) was calculated through the C-V curve and Equations 1 and 2, 20° was not measured, and a value of 8.40 F/g was calculated at 0° with the widest current area, that is, in Example 1-1.

According to the specification, the detailed descriptions of contents that may be sufficiently recognized and inferred by those skilled in the art of the present disclosure have been omitted, and in addition to the specific examples described in the present specification, various modifications are possible within the scope that does not change the technical idea or essential configuration of the present disclosure. Accordingly, the present disclosure may be practiced in other ways than those specifically described and exemplified herein, which may be understood by those skilled in the art.

What is claimed is:

1. A self-reinforced composite comprising:
a matrix comprising carbon nanotubes; and
reinforcements positioned on the matrix and comprising the carbon nanotubes.

2. The self-reinforced composite of claim 1, wherein the matrix comprises a carbon nanotube film, and
the reinforcement comprises carbon nanotube fibers.

3. The self-reinforced composite of claim 2, wherein the carbon nanotube fiber comprises ply fibers in which a plurality of carbon nanotube fibers are twisted together.

4. The self-reinforced composite of claim 2, wherein a diameter of the carbon nanotube fiber is 1 to 80 μm.

5. The self-reinforced composite of claim 1, wherein the self-reinforced composite is in a form in which a part or all of the reinforcement is impregnated into the matrix.

6. The self-reinforced composite of claim 1, wherein the reinforcements are randomly arranged, arranged in parallel, or arranged to cross each other while forming a constant crossing angle, on the matrix.

7. The self-reinforced composite of claim 1, wherein the reinforcements are arranged on the matrix while forming a constant crossing angle of 0° or greater and less than 90°.

8. The self-reinforced composite of claim 1, wherein the reinforcements are arranged on the matrix while forming a constant crossing angle of 0° to 30°.

9. The self-reinforced composite of claim 1, wherein the carbon nanotube comprises at least one selected from the group consisting of a single-walled carbon nanotube (SWCNT), a double-walled carbon nanotube (DWCNT), and a multi-walled carbon nanotube (MWCNT).

10. The self-reinforced composite of claim 1, wherein the self-reinforced composite has a fiber volume fraction of 0.1% to 5%.

11. The self-reinforced composite of claim 1, wherein the self-reinforced composite has an elongation of 4.8% or greater, a tensile strength of 41 MPa or greater, a Young's modulus of 0.9 GPa, and a toughness of 113 MPa or greater.

12. A method for preparing a self-reinforced composite, the method comprising:
(a) preparing a matrix comprising carbon nanotubes;
(b) preparing reinforcements comprising the carbon nanotubes; and
(c) preparing the self-reinforced composite by positioning the reinforcements on the matrix.

13. The method of claim 12, the method comprises (a′) preparing a carbon nanotube dispersion solution prior to Step (a).

14. The method of claim 13, wherein the carbon nanotube dispersion solution comprises:
the carbon nanotubes; and
a solvent comprising alkali metal and aromatic hydrocarbon.

15. The method of claim 14, wherein the alkali metal comprises at least one selected from the group consisting of sodium, potassium, and a combination thereof, and
the aromatic hydrocarbon comprises naphthalene.

16. The method of claim 14, wherein the solvent comprises at least one selected from the group consisting of N,N-dimethylacetamide (DMAc), tetrahydrofuran (THF), dimethyl formamide (DMF), and 1-methyl-2-pyrrolidone (NMP).

17. The method of claim 12, wherein Step (a) comprises:
(a-1) preparing a substrate on which a position where the reinforcements are to be arranged is marked; and
(a-2) preparing the matrix comprising the carbon nanotubes by casting a carbon nanotube dispersion solution on the substrate.

18. The method of claim 12, wherein the reinforcements are arranged on the matrix while forming a constant crossing angle of 0° or greater and less than 90°.

19. An electrode for an electrochemical device comprising the self-reinforced composite of claim 1.

20. The electrode for an electrochemical device of claim 19, wherein the electrode for an electrochemical device is any one selected from the group consisting of an electrode for a primary battery, an electrode for a secondary battery, an electrode for a fuel cell, an electrode for a solar cell, and an electrode for a capacitor.
